(19) United States
(12) Patent Application Publication
(10) Pub. No.: US 2026/0015836 A1
(43) Pub. Date: Jan. 15, 2026

(54) ATMOSPHERIC WATER GENERATOR SUPPLIED WITH PHOTOVOLTAIC SOLAR POWER

(71) Applicant: GLOBAL INVENTIONS, CANNES LA BOCCA (FR)

(72) Inventor: Joel GILBERT, Saint Julien (FR)

(73) Assignee: GLOBAL INVENTIONS, CANNES LA BOCCA (FR)

(21) Appl. No.: 18/993,936

(22) PCT Filed: Jul. 13, 2023
(86) PCT No.: PCT/FR2023/000133

§ 371 Date: Jan. 13, 2025

(30) Foreign Application Priority Data
Jul. 13, 2022 (FR) FR2207215

(51) Int. Cl. E03B 3/28; B01D 53/26; B01D 53/28; B01D 53/30; H02S 40/42

(52) U.S. Cl. CPC E03B 3/28; B01D 53/261; B01D 53/265; B01D 53/28; B01D 53/30; H02S 40/425; B01D 2253/204; B01D 2257/80; B01D 2258/06

(57) ABSTRACT

A photovoltaic device, comprising: a photovoltaic generator whose electrical production power varies; an air humidifier device comprising: a storage compartment for atmospheric water vapor; means for heating and injecting the ambient air into the storage compartment; means for cooling and extracting the air flow available at the outlet of the storage compartment; an atmospheric water vapor condenser, which draws in the air flow previously humidified and cooled by the air humidifier device; a management module of the electrical power produced by the photovoltaic generator and used to electrically power the air humidifier device and the condenser device; said means for cooling and extracting the air flow being supplied with a variable electrical power controlled by the value of the surplus of photovoltaic electrical power available, from when the electrical power produced by the photovoltaic generator is greater than said electrical power used by the condenser.

### FIELD OF THE INVENTION

The present invention relates to the field of atmospheric water generators supplied with electricity by photovoltaic solar energy.

### PRIOR ART

An atmospheric water generator is a device that extracts water vapor from the air, usually by lowering the air temperature until it reaches the condensation temperature or “dew point.” This condensation temperature depends on numerous parameters including the concentration of water vapor in the air, the relative humidity level, and the atmospheric pressure. To lower the air temperature, and therefore create cold, we generally use “heat pump” type devices which use a cycle of compression, expansion and condensation, or devices using thermoelectric cells.

In order to improve the efficiency of atmospheric water generators, there are devices which improve thermal exchanges between the hot zones and the cold zones of “heat pumps”, or devices which use solar thermal or photovoltaic energy. But solar energy is variable and intermittent and devices generating heat and cold are generally not adapted to this energy constraint.

Particularly interesting known atmospheric water generator devices use an adsorption wheel which contains an element which adsorbs humidity from the air at ambient temperature and which returns it under a higher temperature. This adsorbent element is for example silica gel (silicon hydroxide Si(OH)₄)), which is a desiccant. This process of generating water therefore firstly requires heating air and sending it to the adsorbent element to recover the humidity which has been stored in the desiccant, so as to obtain a flow of hot, humid air. Then secondly it is necessary to cool the flow of hot and humid air to condense its water vapor. The advantage of this process is that it can recover water vapor contained in the air even when its humidity level is low, in particular less than 20%.

Furthermore, the relative humidity of the ambient air increases when the temperature drops, and it could then be interesting to operate the atmospheric water generators preferably at night when the ambient temperature is cooler, rather than during the day. However, this is not possible when the water generator is supplied with electricity by photovoltaic solar panels, because these only produce electricity with the energy of the sun, therefore during the day, and it would be too expensive to use electric batteries to operate water generators in this way at night.

An example of a known device is described in document WO 2022/074682 A1. It attempts to partially resolve this dilemma by thermally storing solar energy during the day by raising the temperature of a heat transfer liquid which will then be used to heat the desiccant which initially stored the vapor atmospheric water. This solution has the advantage of operating the water generation device even during the night thanks to the thermal storage of solar energy from the previous day. But this device does not describe a process for producing cold in a dynamic manner, that is to say for producing temperatures lower than the ambient temperature at any time. This would, however, have the advantage of improving the phenomenon of condensation, particularly when the outside air temperature is relatively high, which is often the case, even at night, in many hot countries.
In summary, it can therefore be said that the known atmospheric water generators which operate on solar energy do not completely benefit from ideal environmental conditions since they only operate with solar thermal radiation without generation of cold, possibly supplemented by a moisture storage device in desiccant tanks and heat storage which remains quite expensive. Additionally, they only work during the day, while the humidity in the air is generally higher at night.

### AIM OF THE INVENTION

The device which is the subject of the present invention aims in particular to resolve the problems previously exposed which are not resolved by the atmospheric water generation devices known in the state of the art.

Another aim of the present invention is to propose a device using both photovoltaic solar panels integrated into a system arranged to be capable of producing heat and cold, and this system being provided with buffer storage of humidity in desiccant products to increase the concentration of humidity in the air which will then be treated by a humidity extractor or condenser.

Another aim of the present invention is to propose a device capable of both minimizing the problem of variability of solar energy through intelligent management of the production and use of thermal and photovoltaic electricity, while requiring only a minimum electrical power to ensure the optimal operation of atmospheric water generators, in comparison with the electrical power necessary in known devices.

### SUMMARY OF THE INVENTION

The device(S) which is the subject of the invention is an atmospheric water generator whose function is to extract the water contained in the ambient air and which operates on solar energy. It includes a photovoltaic generator supplying electricity to an air humidifier device and an atmospheric water vapor condenser, as well as a module for managing the electrical power produced by the photovoltaic generator and used by the humidifier and condenser devices.

According to one principle of the invention, solar energy is used both to maximize the temperature and humidity of the ambient air injected into the humidifier device, and to cool the air leaving the humidifier and injected in the condenser, which has the effect of maximizing the efficiency of water generation by the condenser. Preferably, the ambient air injected into the humidifier is heated using solar thermal energy, and the humidity in this heated air is adsorbed by an adsorbent agent contained in the humidifier. Then the optimal cooling of the air before injection into the condenser is achieved using photovoltaic solar energy produced by a photovoltaic generator, more precisely using the surplus P1 of available photovoltaic power, beyond that necessary to supply the condenser with electricity.

The photovoltaic generator has a peak electrical power which is worth Pc and a potential production power at a given moment which is worth P and which varies over time depending on the amount of sunshine.

In fact, a photovoltaic generator transforms the sun's irradiation energy into electrical power which is substantially proportional to the intensity of this light irradiation. As the light intensity of the sun is variable due to its height in the sky and unpredictable cloud passages, the potential electrical power P that the photovoltaic generator can provide is likewise variable over time.

The function of the air humidifier device is to increase in absolute value the quantity of water (i.e. a certain mass of water contained in a given volume of air, independently of other parameters such as the temperature) contained in the air passing through it. As air is a gas whose weight varies depending on its temperature and its capacity to contain water vapor also depends on its temperature, we also define a relative humidity rate of the air as the ratio between the actual water vapor content of the air and its maximum capacity to contain it at a given temperature.

The air humidifier device includes:
a) an atmospheric water vapor storage compartment containing a solid or liquid material capable of adsorbing and then desorbing water vapor. This material plays the same role as a sponge which can absorb water and then release it on demand. This adsorbent/desorbent material is considered a desiccant when it absorbs water from the air.
b) a device for extracting the water vapor contained in the storage compartment, this extractor device comprising means for heating an incoming air flow directed towards the entrance to the storage compartment and means for cooling the flow of outgoing air having passed through the storage compartment and which has become charged with humidity on contact with the desiccant material. The means of heating the incoming air flow can be solar of the thermal or photovoltaic type. It is in fact necessary to provide heat energy to the desiccant material so that it returns its water to the incoming air flow, the absolute humidity of which will therefore increase in the same direction as the temperature of said desiccant material. The heating power can be variable because it depends on the sunshine. The absolute humidity level (quantity of water in grams) of the air leaving the storage compartment will also be variable but higher than that of the air entering this compartment.

The cooling means of the extractor device is preferably supplied with electrical energy by the photovoltaic generator and operates with the excess electrical power P1 which is variable over time and which corresponds to the difference between the power P delivered by the photovoltaic generator and the power P0 necessary to operate the condenser. The cooling of the air leaving the water vapor storage compartment by the cooling means is a thermal step preparatory to the following operation which is the condensation of the water vapor by the condenser.

It should be noted that to heat the air before sending it into the storage compartment of adsorbent material such as silica gel, solar thermal heating will be the easiest and most economical. On the other hand, the temperature of the humid and warm air should preferably not exceed 40° C. leaving the storage compartment and must be cooled before entering the condenser, and this will be done by a heat exchanger with the ambient air whose ventilation power must be as great as possible, that is to say with all the power available at the moment, that is to say in reality with all the surplus P1 of available electrical power of photovoltaic origin.

We then notice that the more sunshine there is and the more solar thermal power there will be to heat the air at the entrance to the humidifier, and the more there will be excess power P1 available to ventilate and cool this air leaving the humidifier.

The process of cooling the air leaving the humidifier is therefore controlled by the surplus of available photovoltaic solar energy, which constitutes a new and very advantageous characteristic in terms of the energy balance and the efficiency of said water generator.

One way of achieving this control is to make the power allocated to cooling the air leaving the humidifier proportional to the surplus power P1, and preferably as close as possible to this surplus P1. It is in fact advantageous to maximize the proportion of the surplus P1 of photovoltaic electrical power used to cool the air flow (12) leaving the storage compartment (4).

The atmospheric water vapor condenser draws in the flow of air previously humidified by the humidifier device. It is supplied with electrical energy by the photovoltaic generator and operates with an electrical power consumption P0 which is intermediate between values P0max and P0min. Unlike the previous air humidification operation whose electrical power consumed is variable and could be zero (in this case the air flow entering the storage device is at a temperature equal to that of the ambient air), the condenser needs a minimum electrical supply power greater than or equal to a positive threshold noted P0min to operate. In fact, the condenser includes its own cooling means and a heating means which are linked by thermal and electrical exchanges, for example of the “heat pump” type, the adjustments, automations and controls of which require a minimum of electrical power P0min to coordinate. There are many heat and cold generating devices which can operate with a very low electrical supply power close to zero, such as those operating with Pelletier effect thermoelectric components, but the energy performances of these devices are much lower than those of compressor-based devices.

The management module (3) of the electrical power produced by the photovoltaic generator (2) controls the electricity supply to the atmospheric water vapor condenser device (89) and the air humidifier device (H). The management module (3) comprises at least one means of measuring the potential electrical power P that the photovoltaic generator (2) can provide at each instant T, and a means of measuring the electrical power P0 consumed at this instant T by the condenser device (89). The management module (3) is further configured to be able to calculate the surplus power, denoted P1, representative of the difference between the potential production power P of the photovoltaic generator (2) at each instant and the actually consumed power P0 at this instant by the condenser device (89), this surplus power P1 is therefore worth P1=P−P0.

The invention therefore particularly relates to a device(S) generating atmospheric water powered by solar energy (1) and including:
a photovoltaic generator (2) whose electrical production power P varies over time (T) depending on the sunshine (1);
an air humidifier device (H) including:
   a) a storage compartment (4) for atmospheric water vapor containing a solid or liquid desiccant material (15) capable of adsorbing and desorbing water vapor, the storage compartment (4) including an air inlet and an air outlet;
   b) means (5) for heating and injecting ambient air arranged so as to heat the ambient air (10) and inject it (11) into the storage compartment (4);
   c) a means (6) for cooling and extracting the air flow (12) available at the outlet of the storage compartment (4) and which has become charged with humidity in contact with the desiccant material (15), the assembly constituted by the heating and injection means (5) and by the cooling and extraction means (6) forming a device (56) for extracting water vapor, capable of using for its operation a variable power supply;
a condenser (89) of atmospheric water vapor, which sucks the air flow (13) previously humidified and cooled by the air humidifier device (H), and which requires an electrical power supply for its operation denoted P0;
a management module (3) of the electrical power produced by the photovoltaic generator (2) and used to electrically power the air humidifier device (H) and the condenser device (89), this management module (3) of the electrical power being configured to measure in real time on the one hand the instantaneous electrical power P that the photovoltaic generator (2) can produce with regard to the power of the solar radiation that it receives, and on the other hand a surplus P1 of photovoltaic electrical power available and not used by the condenser device (89), this surplus P1 of available electrical power being variable and substantially worth P1=P−P0;
the device(S) being characterized in that said means (6) for cooling and extracting the air flow (12) leaving the storage compartment (4) is supplied with a variable electrical power controlled by the value of the surplus P1 of photovoltaic electrical power available at a given instant, in as much as the electrical power P produced by the photovoltaic generator (2) is greater than said electrical power P0 used by the condenser (89).

The surplus electrical power P1 corresponds to the variable electrical power which remains available in production by the photovoltaic generator (2) and which has not been consumed by the water vapor condenser device (89). The management module (3) also controls the shutdown of the two condenser (89) and humidifier (H) devices when the potential power P of the generator (2) is less than the minimum operating power (P0min) required by the condenser (89).

According to one embodiment, the control consists of ensuring that said means (6) for cooling and extracting the air flow (12) leaving the storage compartment (4) is supplied with a variable electrical power which is proportional and as close as possible to said surplus P1 of available photovoltaic electrical power, so as to use the maximum of the surplus P1 of available photovoltaic electrical power to cool the air flow (12) leaving the storage compartment (4).

According to one embodiment of the invention, the means (5) for heating and injecting the ambient air and the means (6) for cooling and extracting the air flow (12) are capable of operating with variable electrical power of PWM type (“Pulse Width Modulation”).

According to an interesting embodiment from the point of view of energy savings, said means (5) for heating and injecting ambient air comprises thermal solar collectors (possibly of the evacuated solar tube type) or thermal hybrids and photovoltaic, associated with an electric fan. In this case, the solar thermal energy from the thermal or hybrid sensors will preheat the incoming air (10) only if the humidifier (H) and the condenser (89) are in operation, that is to say only if the photovoltaic power (P) is greater than the minimum operating power (P0) of the condenser (89).

According to an embodiment, the cooling and extraction means (6) comprises a heat exchanger associated with an electric fan or a compressed air pump. According to one embodiment, the condenser (89) of the atmospheric vapor is configured to send flows of hot air towards the heating and injection means (5) in order to heat the air entering the compartment (4) storage, and/or to send flows of cold air towards the cooling and extraction means (6) in order to cool the air leaving the storage compartment (4).

According to one embodiment, the device comprises a means of heating the interior of the storage compartment (4), in the form of an electrical heating resistance, or of an electromagnetic wave generator capable of irradiating the desiccant (15) by means of waves, for example of the infrared type or of the microwave type, the frequency of which is of the order of 2.4 GHz.

According to one embodiment, the device (56) for extracting the water vapor contained in the compartment (4) or the condenser (89) of the atmospheric vapor comprises a thermodynamic module of the heat pump type using a cycle of compression, condensation, expansion and evaporation, or includes Pelletier effect thermoelectric cells, or includes an electric heating resistance and a cooling fan.

According to a preferred embodiment, the storage compartment (4) and the condenser (89) of the atmospheric vapor operate by means of a cycle of adsorption and desorption of the water vapor.

According to one embodiment, the material (15) contained in the storage compartment (4) is taken from: silica gel, calcium chloride, activated carbon, zeolites, hydrogels, glycols, or a mixture of these, without this list being restrictive because many desiccant materials are possible which have particular adsorption and desorption characteristics, in particular depending on environmental parameters such as temperature and the percentage of relative humidity of the air with which they come into contact.

According to one embodiment, the material (15) contained in the storage compartment (4) is a MOF (acronym for “Metal Organic Framework”) suitable for recovering atmospheric water. Particularly suitable MOFs are for example those known commercially under the references MOF-801 or MOF-841.

According to one embodiment, the water vapor extractor device (56) uses Pelletier effect thermoelectric cells, or an electric heating resistance and air cooling (by means of a fan), and the condenser device (89) of atmospheric vapor operates by means of a cycle of adsorption and desorption of water vapor known and materialized under the name of “adsorption wheel”.

In a particular embodiment, the water vapor extractor device (56) is chosen to be able to operate with variable electrical power of the PWM (“Pulse Width Modulation”) type, which is the case for example if the extractor device (56) includes Joule effect thermal resistors or DC motor fans.

In an advantageous embodiment, the power management module (3) is configured so that, during periods T1, T2, T3 during which the atmospheric water vapor condenser device (89) and the device (56)) extraction of water vapor are stopped due to an instantaneous potential photovoltaic power P too low to power them (P being less than P0), said photovoltaic electrical power P is directed towards and consumed by d other electrical appliances (C1,C2,C3,C4) other than the extraction device (56) and the condenser (89), with an overall electrical power consumption P2 which will be less than or equal to P. This will be suitable for example for the load of electric batteries, or for the process of storing atmospheric water vapor which is done by means of electric fans which pulse the ambient air through the storage compartment (4).

In another embodiment, the management module (3), which is capable of calculating the power P1 representative of the difference between the potential production power P of the photovoltaic generator (2) at each instant and the actually consumed power P0 at this instant by the condenser device (89), the management module (3) comprises a Hall effect direct current intensity sensor (21) which measures in real time the difference between on the one hand the electrical intensity produced by a control photovoltaic cell (22) representative of the potential power P that the generator (2) can produce and on the other hand the electrical intensity actually produced by the photovoltaic generator (2), this difference being representative of the surplus power P1 which will be allocated by the management module (3) for the non-priority power supply of the humidifier device (H).

In another embodiment interesting from the point of view of energy savings, the incoming air flow (10) in the air humidifier device (H) is previously heated by thermal or hybrid thermal and photovoltaic solar collectors (2). In this case, the solar thermal energy from the thermal or hybrid sensors will preheat the incoming air (10) only if the humidifier (H) and the condenser (89) are in operation, that is to say only if the photovoltaic power (P) is greater than the minimum operating power (P0) of the condenser (89).

In another embodiment, the atmospheric vapor condenser (89) is configured to send flows of hot air to the injection and heating means (5) in order to heat the air entering the compartment (4) storage, or to send flows of cold air towards the extraction and cooling means (6) in order to cool the air leaving the storage compartment (4).

In another embodiment, the humidifier (H) comprises means for heating the interior of the storage compartment (4), in the form of an electrical heating resistor or an electromagnetic wave generator capable of irradiate the desiccant (15) by means of waves, for example of the infrared type or of the microwave type (whose frequency is of the order of 2.4 GHz).

In another embodiment, the incoming air flow (10) into the air humidifier device (H) is charged with humidity by means of an air pipe (18) comprising suction openings (19) positioned above or in a vegetated environment (17). In fact, the air (20) which is close to the plants takes care of the humidity which evaporates from the plants (17), both during the day when the temperature increases and promotes the natural evaporation of the plants, as well as during the day. night when the temperature drops and increases the relative humidity of the air. The device (not illustrated in the figures) which makes it possible to recharge the storage compartment (4) with humidity, will also have the advantage of sucking up the humid air (20) near the plants (17) by means of this air pipe (18) to increase its efficiency.

A particular embodiment and use of the device (S) according to the invention concerns a vegetated environment (17), possibly in a greenhouse, or whose plants are positioned on a roof (16) or on the facade of a building (not illustrated), and the irrigation water of which is, for at least part, the condensation water (7) generated by the device (S) generating solar atmospheric water.

Another embodiment and use of the device(S) makes it possible to save space on solar energy collection surfaces, particularly when these are positioned in an urban environment or on a roof, by juxtaposing said photovoltaic solar panels (2) and said air pipe (18) which sucks the humid air (20) from the vegetated environment (17) in order to create between them (2 and 18) suitable thermal exchanges to preheat the humidified air (20) which enters (10) into the air humidifier device (H). This combination between a photovoltaic surface (2) which heats up in the sun and an air pipe (18) which heats up on contact with said photovoltaic surface (2) is an advantageous hybrid system because it makes it possible to reduce the overall surface to capture solar energy while maintaining its efficiency, even when available space is limited.

Another embodiment and use of the device (S) allows it to operate on an isolated site without any electrical connection with a public electrical distribution network. In this case the management module (3) is configured to be able to measure or calculate in real time the power values P0, P1 and P2 without the aid of a connection with any public electrical distribution network.

Finally, in another improved embodiment, the compartment (4) for storing atmospheric water vapor is formed by several compartments containing a material (15) capable of adsorbing or desorbing atmospheric water vapor, each of said compartments capable of operating, individually or in interconnection between them, in adsorption or desorption mode, depending on the humidity rate of the air which leaves said compartments or depending on the weight of the water vapor stored in the different compartments. In fact, the basic operation of the device(S) provides only one compartment (4) for storing humidity in adsorbent materials (15).

However, it may be interesting to store the humidity in a secondary compartment while the main compartment is discharging its humidity, then to reverse the compartments as soon as one of the two is full or empty. This procedure, which can extend to several secondary compartments, makes it possible to operate the device(S) generating atmospheric water throughout the time during which the sunshine (1) is sufficient to supply the electrical power (P0) to the condenser (89) and with pre-humidification by the humidifier device (H) whose efficiency is ensured by the importance of the humidity load of the different compartments in operation. Measuring the humidity load of a given water vapor storage compartment (4) can be carried out simply by measuring its weight, compared to its dry weight.

### DETAILED DESCRIPTION OF THE INVENTION

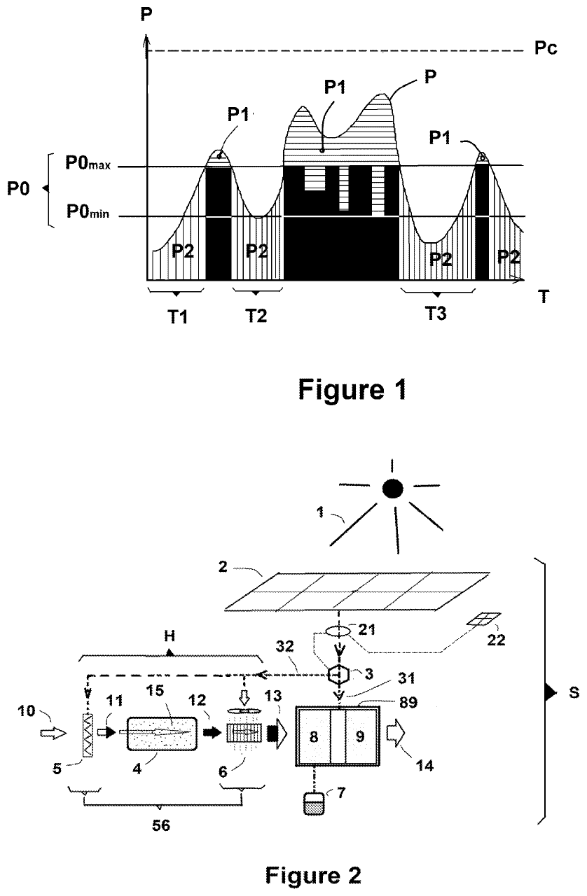

The invention is now described in more detail using indexed FIGS. 1 to 5, in which:

FIG. 1 is a graph representing the evolution as a function of time of the electrical power P that a photovoltaic generator (2) can produce over the course of a day;

FIG. 2 is a schematic representation of a solar device (S) generating atmospheric water according to the invention;

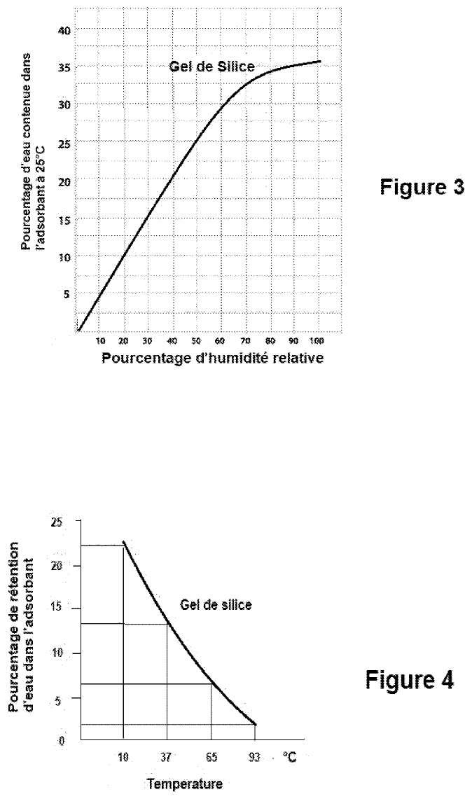

FIG. 3 is a graph representing the water absorption capacity of a silica gel (“silica gel” in Anglo-Saxon terminology) at a given temperature, as a function of the humidity level of the ambient air;

FIG. 4 is a graph of water retention (in %) of silica gel as a function of temperature;

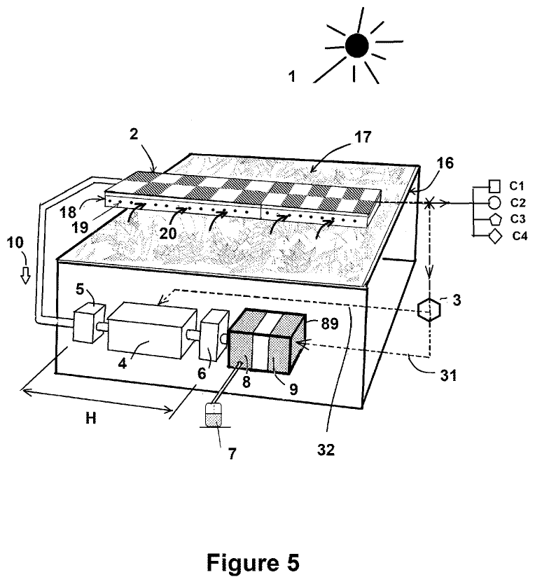

FIG. 5 is a schematic representation of the integration and use of the device (S) for generating atmospheric water according to the invention, in a vegetated environment.

It is referred to FIG. 1. The peak power Pc of a photovoltaic generator (2) like that shown in FIG. 2 is defined as the power that the photovoltaic generator (2) can produce when it is illuminated by solar radiation of 1000 Watts per square meter perpendicular to its surface. The potential power P that the photovoltaic generator (2) can produce during a day depends on the solar irradiation power, which is a variable over time.

This potential electrical power P is used (black area) to supply electricity to a condenser device (89) of atmospheric water vapor (FIG. 2) which operates with a power P0 which can vary between a minimum value P0min and a value maximum P0max which depend on the condenser device (89).

When the potential power P at the output of the photovoltaic generator (2) is greater than P0 (corresponding to the horizontally hatched areas of the graph) the excess power which is worth P1=P−P0 is used to supply electricity to the humidifier device (H) of atmospheric air, therefore the heater device (5) (in a possible case where it is not powered by a solar thermal device or another heating method), but especially the cooler device (6) and the device ventilation (not shown because it can be positioned in various locations on the air flow (10), (11), (12), (13) or (14).

When the electrical power P is less than the operating power P0 of the condenser device (89), then the condenser device (89) and the humidifier device (H) are stopped (corresponding to zones T1, T2, T3 of the graph in the FIG. 1). The production power P of the generator is then worth P2 (corresponding to the hatched areas of vertical lines) and it is used to power additional devices with preferably variable operating power, such as an electric battery or the humidity charge of said storage compartment (4) which will preferably be done during the night by means of a flow of fresh air which will pass through said compartment (4). Recharging the humidifier (H) with humidity should preferably be done with ambient air and when the condenser is not in operation, therefore mainly at night and by means of a fan powered by electricity from the batteries. which will be charged during the day when the power P will not be sufficient to power the condenser (89) and the humidifier (H) in periods T1, T2, T3 in FIG. 1.

Furthermore, it would not be wise to continue to supply the humidifier (H) with ambient air during the day because the compartment (4) would cool down while a period of operation (black areas) could occur again, and it will have to reheat the desiccant which will have cooled. These periods of heating followed by cooling followed by heating would cause energy losses which could reduce the efficiency of the device, whereas a humidity recharge operation at night allows you to benefit (continuously) from cooler air and with less energy expenditure (only a fan, the one which could be associated with the heating device (5), and with an air outlet (12) this time drier and which would be oriented (by means of a three-way valve channels) towards the outside and not towards the cooling device (6) and neither towards the condenser (89).

FIG. 2 is a diagram representative of the main elements of the solar atmospheric water generator device(S) according to the invention. Solar energy (1) is transformed into electricity by a photovoltaic generator (2) which supplies electricity to both a device (89) for condensing atmospheric water vapor via a supply line (31) and a device humidifier (H) of atmospheric air (10) via a supply line (32). The humidifying device (H) comprises a compartment (4) which contains a material (15) which adsorbs and desorbs water vapor as a function of its temperature. The compartment (4) has an inlet of a flow of hot air (11) which has been heated by a heating means (5) such as for example an electrical resistance or a solar thermal device, and an outlet of hot air and wet (12).

The hot air from the inlet (11) is charged with humidity as it passes through the adsorbent/desorbent material (15) and emerges as hot, humid air (12). The outgoing air flow (12) is then cooled (13) by a cooling means (6) electrically supplied with an electrical power controlled by the surplus power P, for example proportional to it, via a management module (3). This can ideally be the entire surplus P1 of available power, or only part of this surplus.

This cooled air (13) is then sucked in by the condenser (89) which comprises on the one hand a cooling means (8) making it possible to condense the water vapor on a cold surface to obtain water (7), and which further comprises means (9) for extracting hot air (14) from the device. The means (8,9) can be part of a “heat pump” type device which operates for example using a compressor and the search for performance requires an electrical supply whose power varies between a value minimum P0min and a maximum value P0max.

The heating (5) and cooling (6) means of the humidifier (H) can be part of a device (56) whose electrical power supply is compatible with variable electrical power. This may involve heating using, for example, electrical resistors heating by the Joule effect, and cooling by a humid air/ambient air heat exchanger using electric fans. Alternatively, Pelletier effect thermoelectric cells can be used powered by a PWM type voltage (acronym for “Pulse Width Modulation”).

The electrical powers (P0, P1, P2) consumed by the different modules (89, 56) are managed by the management module (3) which measures or calculates in real time the different powers P0, P1, P2. This allows the condenser (89) and the humidifier (H) to be started only when the potential power P is sufficient to power the condenser (89) (i.e. when P>P0). In addition, the management module (3) is configured to control the variable power surplus P1 which is worth P1=P−P0, and to power the humidifier (H) with the available surplus power P1, so as to use the maximum power (P) from the photovoltaic generator (2).

FIG. 3 is a graphical representation of the evolution of the adsorption capacity of silica gel (in grams of water per 100 grams of silica gel) at a temperature of 25° C. and as a function of relative humidity. It can be seen that the adsorption capacity is relatively proportional to the relative humidity. With a maximum adsorption of 33 g per 100 g at 80% relative humidity.

Other even more effective water-absorbing materials could be used, such as for example MOFs (acronym for “Metal Organic Framework”), in particular MOFs known under the references MOF 801 or MOF 841.

FIG. 4 is another graphical representation of the evolution of the adsorption capacity of silica gel (in grams of water per 100 grams of gel) as a function of temperature. It can be seen that the adsorption capacity is inversely proportional to the temperature with a minimum adsorption around 90° C. which corresponds to an adsorption rate of approximately 2 grams of water per 100 grams of silica gel. Hence the need to heat the silica gel contained in the tank (4) using the heating means (5) to extract the water from the silica gel.

FIG. 5 represents a particular mode of use of the device (S) according to the invention, in which the solar generator (2) is a hybrid generator (photovoltaic and thermal) and is positioned in a vegetated environment (17). The vegetated environment (17) is for example located on a roof (16) and the humid air (20) created by the plants (17) is sucked in through orifices (19) positioned along a pipe (18) which is attached to the photovoltaic solar panel (2) so that the heat of the solar radiation (1) which appears on the surface of said photovoltaic panel (2) is transmitted by conduction to a flow of incoming humid air (20) which circulates inside said pipe (18) and which heats up before circulating (10) and entering the humidifying device (H).

The humid air flow (20) is preheated by the hybrid solar panel (2) and is optionally heated again by a heating means (5) supplied with electricity by the photovoltaic generator (2) with a variable electrical power P1 which is a function of the solar radiation (1) of the moment. The humid air flow (10) passes through the compartment (4) of the humidifier (H), then is cooled by a cooling means (6) before entering the device (89) to obtain water condensation (7).

The management module (3) controls the variable power electrical supply of the humidification device (H) and the fixed power electrical supply of the condensation device (89), following a logic which is that the electrical power (P0) dedicated to the condenser (89) has priority, and the remaining surplus power (P1) is allocated to the humidifier (H). In this particular embodiment, the condensation water (7) is used to water the vegetation (17) on a roof (16), thus creating an economical recycling of the watering water.

The atmospheric water generating device according to this embodiment comprises additional electrical devices (C1, C2, C3, C4) optionally powered by the photovoltaic generator (2) and used if necessary for the operation of additional applications (not shown) such as the charging of an electric battery, a lift pump for roof watering, the circulation of air flows by fan, the lighting of the premises, the treatment of condensation water to make it drinkable.

### EXEMPLARY EMBODIMENT

In a practical embodiment, an atmospheric water generator (S) according to the invention comprises:
25 m2 of photovoltaic panels (2) with a peak power of Pc=5 kWp.
An inverter (not shown) which transforms the direct current from the photovoltaic panels (2) into an alternating current of 230 V in self-consumption mode (without connection to a public electricity network).
   The device is located at a latitude of 21° S (on Reunion Island).
   The photovoltaic panels (2) receive an overall luminosity per day equivalent to 6 hours of sunshine at 1000 W/m2, i.e. a daily production of approximately 6×5 kWp=30 kWh when all of the electrical energy produced is consumed.

A compartment (4) for humidifying the ambient air contains 200 kilograms of silica gel in beads of 3 mm in diameter and can adsorb 20% of its weight in water at 20° C. and only 7% of its weight in water at 65° C., and can therefore restore 13% of its water thanks to this increase in temperature, or 26 liters of water.

A dehumidifier-type water vapor condenser (89) operates with an average electrical power of approximately P0=2.2 KW and produces 2 liters of water (7) per hour when the ambient air is at 20° C. and at 60% relative humidity, and when it operates without the humidifier (H) during the 6 hours of operation it therefore produces 2×6=12 liters of water.

When the humidifier (H) operates thanks to the surplus power P1 obtained using the management module (3), then the condenser (89) with the same operating power of 2.2 kW condenses 4 liters of water (7) per hour, or 24 liters during the 6 hours of operation.

Thermal solar panels (not shown) will be able to heat the flow of ambient air entering the water vapor storage compartment (4) from 20° C. to 65° C., in order to extract the vapor from water from the desiccant, then cool the flow of humidified air leaving the compartment from 65° C. to 30° C. and produce 4 liters of water vapor per hour at the condenser (89), i.e. the double what it would have condensed under normal conditions of temperature and relative humidity of the ambient air and without the humidification device (H).

This was made possible thanks to the photovoltaic energy management module (3) which was able to give priority to the use of electrical production P to the dehumidifier/condenser (89) and use the remaining surplus energy P1 to the cooling function of the humidifier (H). Without this management according to the invention, all of the potential photovoltaic energy P could not have been consumed with maximum efficiency for this application of generating solar atmospheric water(S).

### ADVANTAGES OF THE INVENTION

Ultimately, the invention responds well to the objectives set by proposing a device which solves the problem of the variability of solar energy thanks to intelligent management of the production of photovoltaic electricity which is redistributed in part for the condensation of water atmospheric and partly to concentrate the humidity of the ambient air during periods of low sunlight, or even during the night, thanks to a humidity storage device combined with a management module (3) which distributes optimally energy solar power supply between the condenser and the humidifier.

Consequently, the device(S) according to the invention makes it possible to produce more water per unit of available photovoltaic surface area. The additional water is obtained at low cost, since the device(S) only adds to known systems inexpensive, non-polluting components, having a long lifespan, and infinitely recyclable, as is the case for silica gel. The surplus of photovoltaic power obtained and used thanks to intelligent management by the management module (3) is of the order of 30-40%, is used here to generate water, while this surplus of available power is typically not used and therefore wasted in existing systems.

The invention is particularly useful, particularly in countries in the South which are developing and need systems capable of producing electrical energy and drinking water in an optimized manner. The invention is more generally useful when the photovoltaic generator is positioned on an isolated site, without any electrical connection with a public electricity distribution network.

Ultimately, the device according to the invention makes it possible to implement a virtuous cycle: more sunshine leads to more thermal heating and more photovoltaic power generated, therefore more surplus photovoltaic power P1 available and not consumed by the condenser. More excess power P1 makes it possible to increase the means of cooling the flow of humid air leaving the humidifier, and therefore to increase the performance of the atmospheric water condenser. In summary, the more the air is heated at the entrance to the humidifier, the more it will be cooled at the outlet thanks to the excess power P1. This particularity makes it possible to make the water generation device according to the invention particularly effective.

1. Atmospheric water generating device powered by solar energy and including:
a photovoltaic generator whose electrical production power P varies over time depending on the amount of sunshine;
an air humidifier device comprising:
a) a storage compartment for atmospheric water vapor containing a solid or liquid desiccant material capable of adsorbing and desorbing water vapor, the storage compartment comprising an air inlet and an air outlet;
b) a means for heating and injecting ambient air arranged so as to heat the ambient air and inject it into said storage compartment;
c) a means for cooling and extracting the air flow leaving the storage compartment and which has become charged with humidity in contact with the desiccant material, the assembly consisting of the heating and injection means and the cooling and extraction means forming a device for extracting water vapor, capable of using for its operation a variable power supply;
a condenser of atmospheric water vapor, which sucks the air flow previously humidified and cooled by the air humidifier device, and which requires an electrical power supply denoted P0 for its operation;
a management module for managing the electrical power produced by the photovoltaic generator and used to electrically power the air humidifier device and the condenser device, this management module being configured to measure in real time on the one hand the instantaneous electrical power P that the photovoltaic generator can produce with regard to the power of the solar radiation that it receives, and on the other hand a surplus P1 of photovoltaic electrical power available and not used by the condenser device, this surplus P1 of available electrical power being variable and substantially worth P1=P−P0;
the device being characterized in that said means for cooling and extracting the air flow leaving the storage compartment is supplied with a variable electrical power controlled by the value of the surplus P1 of photovoltaic electrical power available at a given instant, as long as the electrical power P produced by the photovoltaic generator is greater than said electrical power P0 used by the condenser.

2. Device according to claim 1, characterized in that said means for cooling and extracting the air flow leaving the storage compartment is supplied with a variable electrical power which is proportional and as close as possible to said surplus of available photovoltaic electrical power, so as to use the maximum of the surplus of available photovoltaic electrical power to cool the air flow leaving the storage compartment.

3. Device according to claim 1, characterized in that the means for heating and injecting the ambient air and the means for cooling and extracting the air flow leaving the storage compartment are capable of operating with variable electrical power of the PWM type (“Pulse Width Modulation”).

4. Device according to claim 1, characterized in that said means for heating and injecting ambient air is electrically powered by thermal solar collectors possibly of the vacuum solar tube type or sensors thermal and photovoltaic hybrids, associated with a fan or an electric air pump.

5. Device according to claim 1, characterized in that the means for cooling and extracting the air flow leaving the storage compartment comprises a heat exchanger associated with an electric fan or an electric air pump.

6. Device according to claim 1, characterized in that the condenser of the atmospheric vapor is configured to send flows of hot air towards the heating and injection means in order to heat the air entering the storage compartment, or to send flows of cold air to the cooling and extraction means in order to cool the air leaving the storage compartment.

7. Device according to claim 1, characterized in that it comprises a means of heating the interior of the storage compartment, in the form of an electrical heating resistor or a generator electromagnetic waves capable of irradiating the desiccant by means of waves, for example of the infrared type or of the microwave type, the frequency of which is of the order of 2.4 GHz.

8. Device according to claim 1, characterized in that the device for extracting the water vapor contained in the storage compartment, or the condenser of the vapor atmospheric, comprises a heat pump type thermodynamic module using a cycle of compression, condensation, expansion and evaporation, or comprises Pelletier effect thermoelectric cells, or comprises an electrical heating resistance and a cooling fan.

9. Device according to claim 1, characterized in that the storage compartment and the condenser of the atmospheric vapor operate by means of a cycle of adsorption and desorption of the vapor of water.

10. Device according to claim 1, characterized in that the material contained in the storage compartment is taken from:
silica gel, calcium chloride, activated carbon, zeolites, hydrogels, glycols, or MOFs (acronym for “Metal Organic Framework”) suitable for the recovery of atmospheric water.

11. Device according to claim 10, characterized in that the material contained in the storage compartment is MOF-801 or MOF-841.

12. Device according to claim 1, characterized in that the power management module is configured so that, during periods during which the condenser and the device for extracting water vapor are stopped due to a photovoltaic power P that is too low to power them (P being less than P0), said photovoltaic electrical power P is consumed, at least for a part denoted P2, for charging electric batteries, or for powering fans pulsing ambient air through the storage compartment during another period preferably chosen during the night.

13. Device according to claim 1, characterized in that the air flow entering the air humidifier device is charged with humidity by means of an air conduit comprising air suction openings positioned above or in a vegetated environment.

14. Device according to claim 13, characterized in that the vegetated environment consists of plants positioned on a roof or on the facade of a building, and at least part of the condensation water generated by the device is used for watering said plants.

15. Device according to claim 13, characterized in that said photovoltaic solar panels and said air pipe which sucks in the humid air coming from the vegetated environment are juxtaposed in order to create thermal exchanges between them capable of preheating the humidified air which enters the air humidifier device.

16. Device according to claim 1, characterized in that it is installed on an isolated site without any electrical connection with a public electrical distribution network.

17. Device according to claim 1, characterized in that the storage compartment for atmospheric water vapor comprises several compartments containing a material capable of adsorbing or desorbing said water vapor atmospheric, each of said compartments being able to operate, individually or interconnected with each other, in adsorption or desorption mode, depending on the humidity rate of the air leaving said compartments or depending on the weight of the vapor of water stored in the different compartments.
